(19) United States
(12) Patent Application Publication
(10) Pub. No.: US 2024/0123909 A1
(43) Pub. Date: Apr. 18, 2024

(54) Pickup Toolbox System

(71) Applicant: Terry Martyszenko, Ogallala, NE (US)

(72) Inventor: Terry Martyszenko, Ogallala, NE (US)

(21) Appl. No.: 17/967,419

(22) Filed: Oct. 17, 2022

(51) Int. Cl. B60R 9/06; B60R 11/06

(52) U.S. Cl. CPC B60R 9/06; B60R 11/06; B60R 2011/004

(57) ABSTRACT

A pickup toolbox system includes a pickup truck having a pickup bed. A storage module is coupled to and positioned on the pickup bed. The storage module and the pickup truck collectively define a container forming a storage compartment. A top side of the container is open to the storage compartment. The storage module also comprises a toolbox, which is positionable in a closed position such that the toolbox covers the storage compartment. The toolbox is slidable to at least partially expose the storage compartment. The toolbox also comprises a box that has a chamber positioned therein.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to toolbox systems and more particularly pertains to a new toolbox system for storing tools in compartments housed on a bed of a pickup truck.

### (2) Description of Related Art Including Information Disclosed Under 37 CFR 1.97 and 1.98

The prior art relates to toolbox systems for pickup truck beds, including myriad examples of toolbox systems which include a plurality of lockable storage compartments. The prior art also discloses a toolbox system which has a cover for the truck bed that slides to reveal compartments for tool storage.

### (h) BRIEF SUMMARY OF THE INVENTION

An embodiment of the disclosure meets the needs presented above by generally comprising a pickup truck having a pickup bed. The pickup bed has a floor panel, a first lateral panel, and a second lateral panel. Each of the first lateral panel and the second lateral panel extends upwardly from the floor panel and has an upper edge. The pickup bed has a front end and a rear end, with a tailgate positioned at the rear end of the pickup bed.

A storage module is coupled to and positioned on the pickup bed. The storage module and the pickup truck collectively define a container forming a storage compartment. A top side of the container is open to the storage compartment. The storage module also comprises a toolbox, which is positionable in a closed position such that the toolbox covers the storage compartment. The toolbox is slidable to at least partially expose the storage compartment. The toolbox also comprises a box that has a chamber positioned therein.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a storage module of a pickup toolbox system according to an embodiment of the disclosure.

FIG. 2 is a perspective view of a storage module of an embodiment of the disclosure.

FIG. 3 is a top view of a storage module of an embodiment of the disclosure.

FIG. 4 is a top view of an embodiment of the disclosure.

FIG. 5 is a side view of an embodiment of the disclosure.

FIG. 6 is a rear view of an embodiment of the disclosure.

FIG. 7 is a rear view of an embodiment of the disclosure.

FIG. 8 is a perspective in-use view of an embodiment of the disclosure.

### (j) DETAILED DESCRIPTION OF THE INVENTION

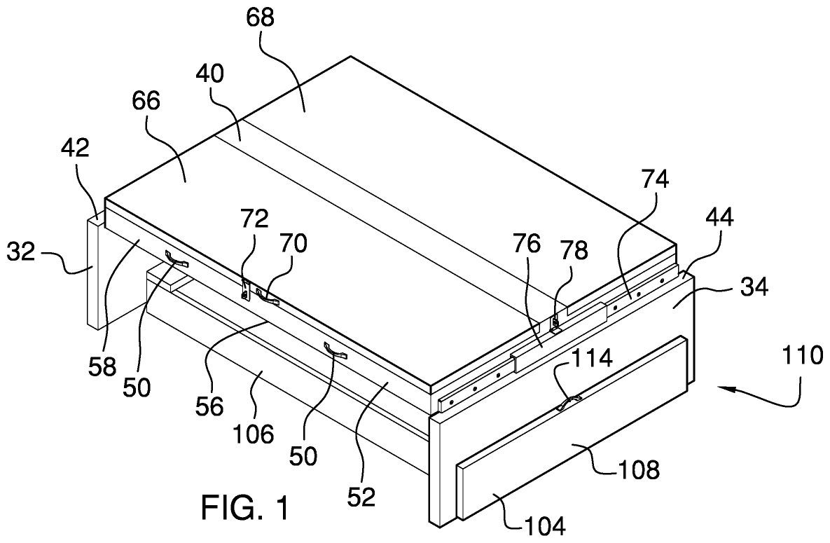

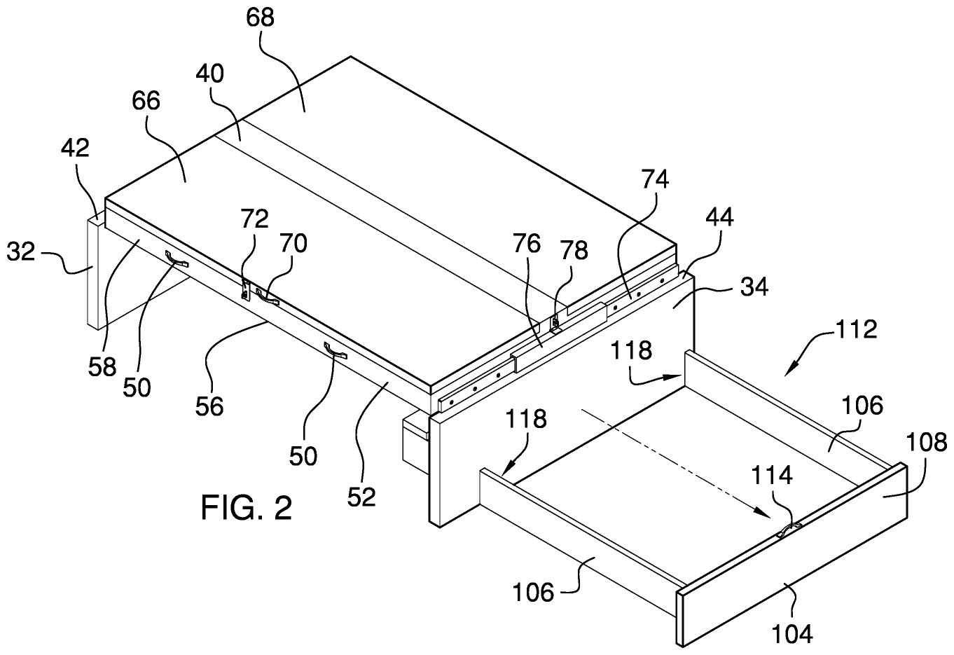

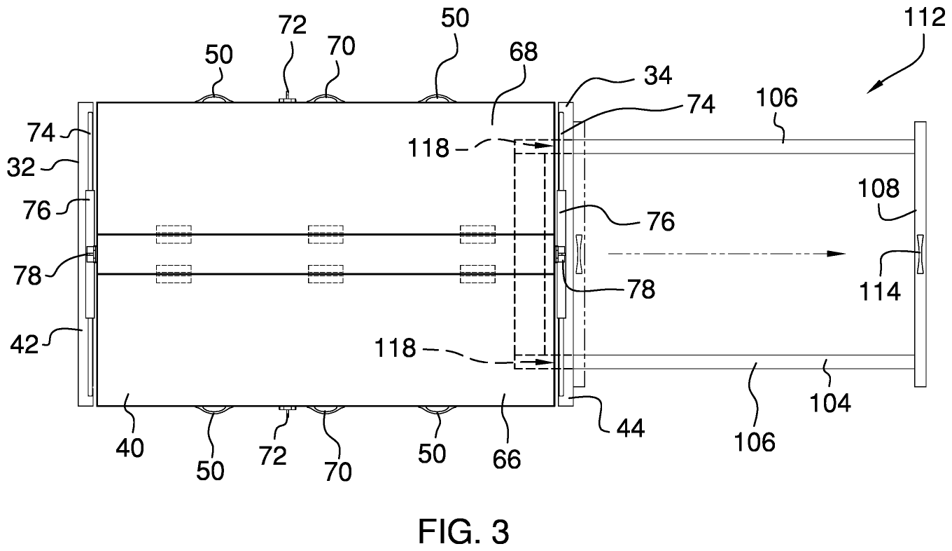

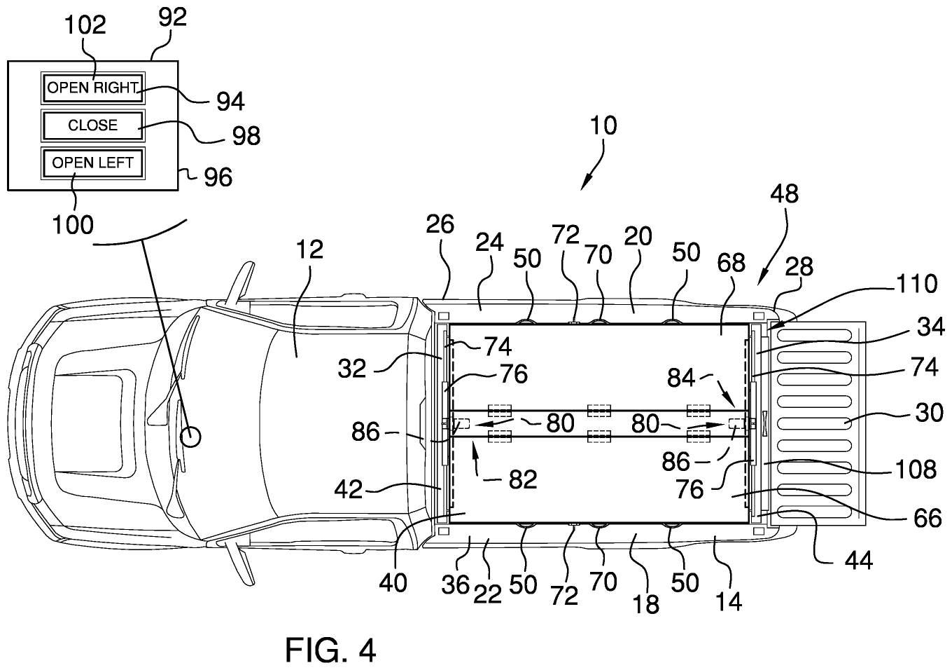

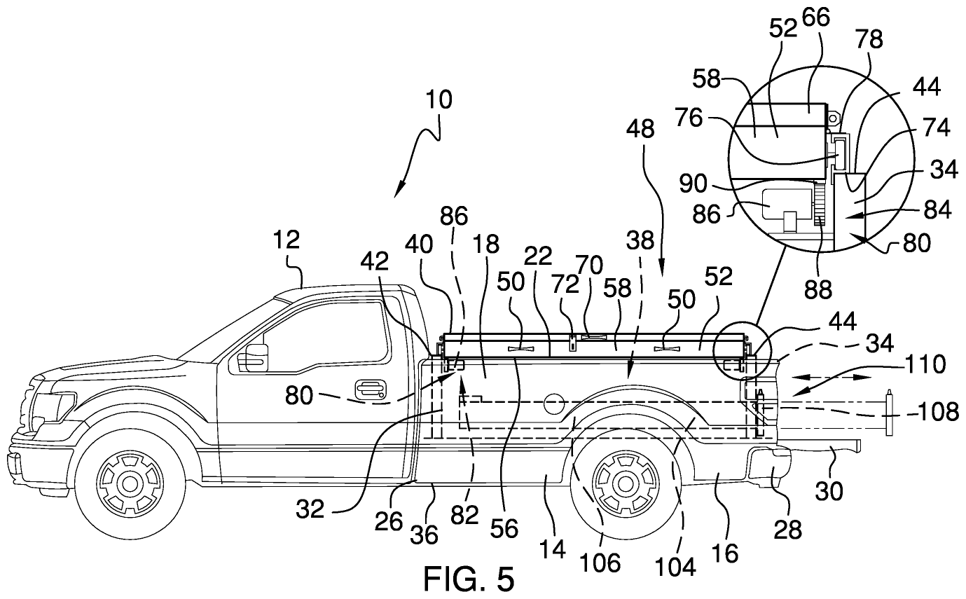

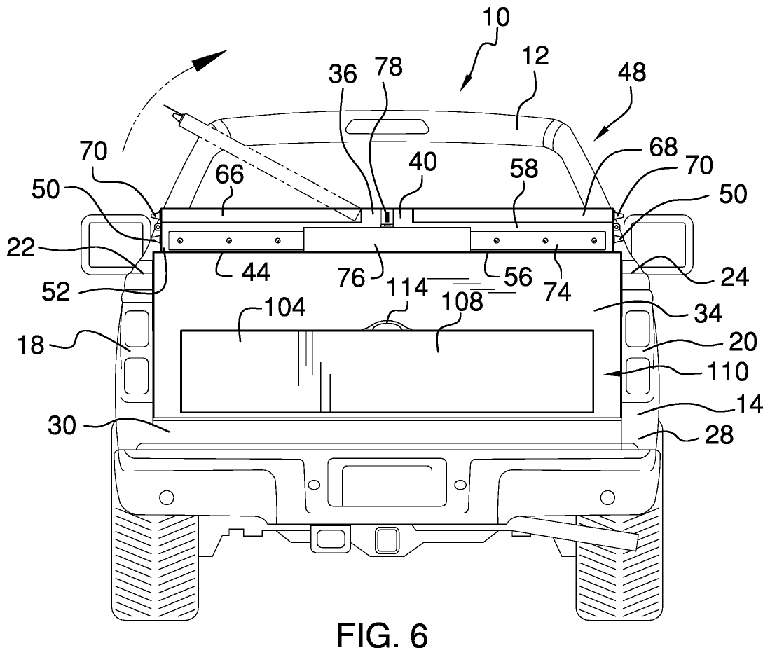

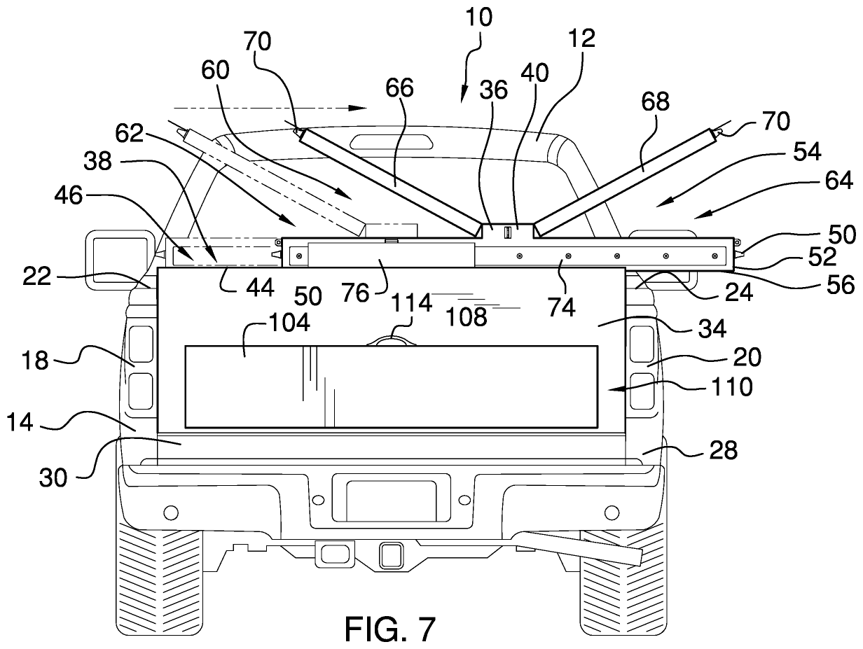

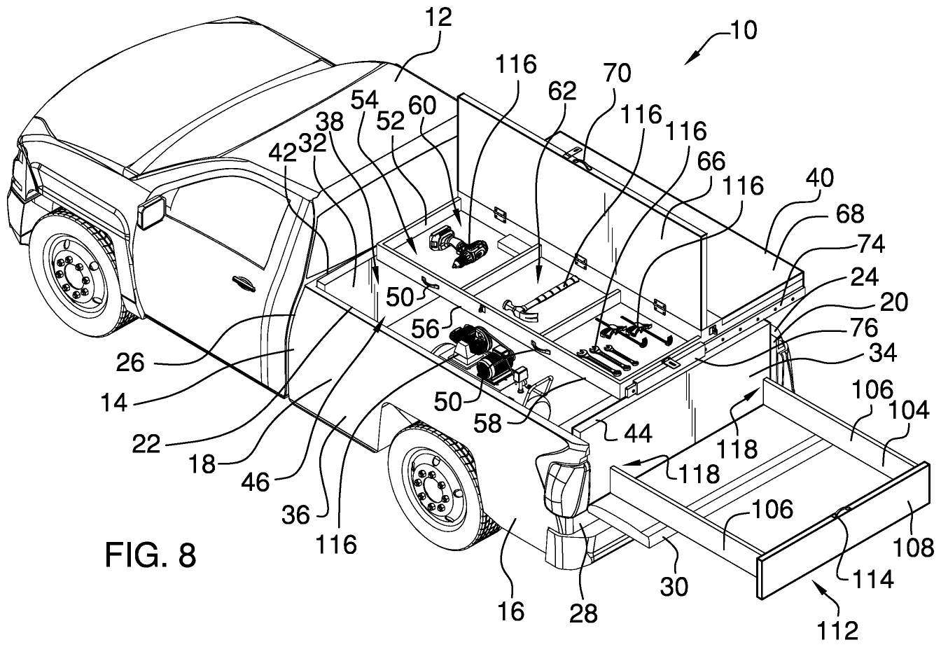

With reference now to the drawings, and in particular to FIGS. 1 through 8 thereof, a new toolbox system embodying the principles and concepts of an embodiment of the disclosure and generally designated by the reference numeral 10 will be described.

As best illustrated in FIGS. 1 through 8, the pickup toolbox system 10 generally comprises

a pickup truck 12 with a pickup bed 14. The pickup bed 14 has a floor panel 16, a first lateral panel 18, and a second lateral panel 20. Each of the first lateral panel 18 and the second lateral panel 20 extends upwardly from the floor panel 16. The first lateral panel 18 has an upper edge 22, and the second lateral panel 20 has an upper edge 24. The pickup bed 14 also has a front end 26 and a rear end 28, with a tailgate 30 positioned at the rear end 28.

A front panel 32 is coupled to the pickup bed 14 and is positioned to extend between the first lateral panel 18 and the second lateral panel 20 adjacent to the front end 26 of the pickup bed 14. A rear panel 34 is also coupled to the pickup bed 14 and is positioned to extend between the first lateral panel 18 and the second lateral panel 20 adjacent to the tailgate 30 of the pickup bed 14. The pickup bed 14, the front panel 32, and the rear panel 34 collectively define a container 36 forming a storage compartment 38. A top side 46 of the container 36 is open to the storage compartment 38.

A toolbox 40 is slidably coupled to the front panel 32 and the rear panel 34. The toolbox 40 is positioned on an upper surface 42 of the front panel 32 and an upper surface 44 of the rear panel 34 and covers the storage compartment 38 when in a closed position 48. The toolbox 40 is movable from the closed position 48 in a first direction over the upper edge 22 of the first lateral panel 18 to expose the storage compartment 38 adjacent to the second lateral panel 20 and in a second direction over the upper edge 24 of the second lateral panel 20 to expose the storage compartment 38 adjacent to the first lateral panel 18. In alternative embodiments the toolbox 40 may expose the storage compartment 38 by sliding a different direction from the first direction and the second direction. Positioning handles 50 may be attached to the toolbox 40 for facilitating moving the toolbox 40.

The toolbox 40 comprises a box 52 with a chamber 54 positioned therein. The box 52 has a base wall 56 and a perimeter wall 58 extending upwardly therefrom. The box 52 also has a top side 60 which is open to the chamber 54 and faces upwardly away from the pickup bed 14. The chamber 54 has a first lateral portion 62 positioned adjacent the first lateral panel 18 and a second lateral portion 64 positioned adjacent the second lateral panel 20 when the toolbox 40 is in the closed position 48. A first lid 66 is mounted to the box 52 for covering and exposing the first lateral portion 62 of the chamber 54 and a second lid 68 mounted to the box 52 for covering and exposing the second lateral portion 64 of the chamber 54. Each of the first lid 66 and the second lid 68 are pivotably coupled to the box 52, but may be slidably coupled, removably coupled, or the like. Lid handles 70 may also be attached to each of the first lid 66 and the second lid 68 for facilitating opening and closing the first lid 66 and the second lid 68. The toolbox 40 may also include locks, latches 72, or the like for securing each of the first lid 66 and the second lid 68 to the box 52.

In one embodiment, the toolbox 40 is slidably coupled to the front panel 32 and the rear panel 34 via at least one slider member 74 movable along a channel 76. In this embodiment, the channel 76 may at least partially surround the slider member 74 such that the toolbox 40 cannot be lifted laterally away from the channel 76. Other embodiments may include wheels, rollers, runners, or the like to slide the toolbox 40 along one or more tracks. These embodiments may also include flanges or other obstructions for preventing lateral removal of the toolbox 40. Instead of a front panel 32 and a rear panel 34, the system 10 may alternatively include other conventional structures for mounting the toolbox 40 to the pickup bed 14 such as one or more columns, cross beams extending over the pickup bed 14, brackets, or the like. In some cases, the storage compartment 38 may be entirely formed by the pickup bed 14 with the toolbox 40 mounted directly to the pickup bed 14.

The system 10 may also include a securement mechanism 78 for securing the toolbox 40 in the closed position 48 such that it does not inadvertently shift, for example, while the pickup truck 12 is in motion. This securement mechanism 78 may include a lock, latch, strap, or the like engaging the toolbox 40 and at least one of the front panel 32, the rear panel 34, and the pickup bed 14.

A drive assembly 80 engages the toolbox 40 and is configured for selectively moving the toolbox 40 relative to the pickup bed 14. The drive assembly 80 may have its own power source which may include a battery. Or the drive assembly 80 may use the pickup truck's 12 engine, battery, or the like. The drive assembly 80 may also be configured for securing the toolbox 40 in the closed position 48 when not operating to move the toolbox 40. The drive assembly 80 may comprise a front module 82 engaging the front panel 32 and the toolbox 40 and a rear module 84 engaging the rear panel 34 and the toolbox 40. The drive assembly 80 includes a motor 86, a pinion 88, and a rack 90 such that the motor 86 rotates the pinion 88 to travel along the rack 90 when the drive assembly 80 is actuated. Alternatively, the drive assembly 80 may include a hydraulic ram, belt drive, or the like to move the toolbox 40. A controller 92 is operatively coupled to the drive assembly 80 which comprises a control circuit 94 and an input module 96. The input module 96 includes a close input 98 for moving the toolbox 40 to the closed position 48, a first open input 100 for moving the toolbox 40 in the first direction, and a second open input 102 for moving the toolbox 40 in the second direction.

An extendable support member 104 is slidably mounted to the rear panel 34 such that the support member is extendable rearwardly of the rear panel 34. The extendable support member 104 includes a pair of lateral sliders 106 and a cross member 108 is coupled to and extends between the pair of lateral sliders 106. The rear panel 34 has a pair of apertures 118 extending therethrough and into the storage compartment 38 such that each of the pair of apertures 118 receives one of the lateral sliders 106 therethrough. The extendable support member 104 is positionable in a retracted position 110 such that the cross member 108 is positioned adjacent the rear panel 34 and is positionable in an extended position 112 such that the cross member 108 is spaced rearwardly away from the rear panel 34. The extendable support member 104 is configured for supporting a workpiece across the pair of lateral sliders 106 when in the extended position 112. The extendable support member 104 may also have a support member handle 114 for facilitating moving the extendable support member 104.

In use, each of the first lid 66 and the second lid 68 are opened to access the chamber 54 of the toolbox 40 for storage of items including, for example tools 116. The first open input 100 is actuated to operate the drive assembly 80 to open the toolbox 40 in the first direction such that the storage compartment 38 is accessible adjacent the first lateral panel 18. The second open input 102 is actuated to operate the drive assembly 80 to open the toolbox 40 in the second direction such that the storage compartment 38 is accessible adjacent the second lateral panel 20. And the close input 98 is actuated to operate the drive assembly 80 to move the toolbox 40 to the closed position 48. The extendable support member 104 is positioned in the extended position 112 to support a workpiece across the pair of lateral sliders 106. The workpiece may be, for example, an item meant to be cut, in which case the extendable support member 104 may be used in the manner of a sawhorse.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pickup toolbox system comprising:
a pickup truck having a pickup bed, the pickup bed having a floor panel, a first lateral panel, and a second lateral panel, each of the first lateral panel and the second lateral panel extending upwardly from the floor panel and having an upper edge, the pickup bed having a front end and a rear end, the pickup truck having a tailgate positioned at the rear end of the pickup bed; and
a storage module being coupled to and positioned on the pickup bed, the storage module and the pickup truck collectively defining a container forming a storage compartment, a top side of the container being open to the storage compartment, the storage module comprising:
a toolbox being positionable in a closed position such that the toolbox covers the storage compartment, the toolbox being slidable to at least partially expose the storage compartment, the toolbox comprising a box having a chamber positioned therein.

2. The system of claim 1, wherein the storage module further comprises:
a front panel being coupled to the pickup bed, the front panel being positioned adjacent the front end of the pickup bed and extending between the first lateral panel and the second lateral panel;
a rear panel being coupled to the pickup bed, the rear panel being positioned adjacent the tailgate of the pickup truck and extending between the first lateral panel and the second lateral panel;
the pickup bed, the front panel, and the rear panel collectively defining the container;
the toolbox being slidably coupled to at least one of the front panel and the rear panel.

3. The system of claim 2, wherein the toolbox is positioned on an upper surface of the front panel and an upper surface of the rear panel.

4. The system of claim 1, wherein the toolbox is movable from the closed position in a first direction over the upper edge of the first lateral panel to expose the storage compartment adjacent to the second lateral panel, the toolbox being movable from the closed position in a second direction over the upper edge of the second lateral panel to expose the storage compartment adjacent to the first lateral panel.

5. The system of claim 1, wherein the box of the toolbox has a base wall and a perimeter wall extending upwardly therefrom, the box having a top side being open to the chamber, the top side facing upwardly away from the pickup bed, the chamber having a first lateral portion positioned adjacent the first lateral panel and a second lateral portion positioned adjacent the second lateral panel when the toolbox is in the closed position, the toolbox further comprising:
a first lid being mounted to the box for covering and exposing the first lateral portion of the chamber; and
a second lid being mounted to the box for covering and exposing the second lateral portion of the chamber.

6. The system of claim 5, wherein each of the first lid and the second lid are pivotably coupled to the box.

7. The system of claim 1, wherein the storage module further comprises a drive assembly engaging the toolbox and being configured for selectively moving the toolbox relative to the pickup bed.

8. The system of claim 7, wherein the drive assembly further comprises a front module engaging the front panel and the toolbox and a rear module engaging the rear panel and the toolbox.

9. The system of claim 7, wherein the drive assembly further comprises a motor, a pinion, and a rack.

10. The system of claim 7, wherein the storage module further comprises a controller being operatively coupled to the drive assembly, the controller comprising a control circuit and an input module, the input module including a close input for moving the toolbox to the closed position and an open input for moving the toolbox to at least partially exposing the storage compartment.

11. The system of claim 7, wherein:
the toolbox is movable from the closed position in a first direction over the upper edge of the first lateral panel to expose the storage compartment adjacent to the second lateral panel, the toolbox being movable from the closed position in a second direction over the upper edge of the second lateral panel to expose the storage compartment adjacent to the first lateral panel; and
the storage module further comprises a controller being operatively coupled to the drive assembly, the controller comprising a control circuit and an input module, the input module including a close input for moving the toolbox to the closed position, a first open input for moving the toolbox in the first direction, and a second open input for moving the toolbox in the second direction.

12. The system of claim 1, wherein the storage module further comprises an extendable support member being slidably mounted to the rear panel such that the support member is extendable rearwardly of the rear panel, the extendable support member being configured for supporting a workpiece when in the extended position.

13. The system of claim 12, wherein the extendable support member includes a pair of lateral sliders and a cross member being coupled to and extending between the pair of lateral sliders, the rear panel having a pair of apertures extending therethrough and into the storage compartment, each of the pair of apertures receiving one of the lateral sliders therethrough, the extendable support member being positionable in a retracted position such that the cross member is positioned adjacent the rear panel, the extendable support member being positionable in an extended position such that the cross member is spaced rearwardly away from the rear panel, the extendable support member being configured for supporting a workpiece across the pair of lateral sliders when in the extended position.

14. A pickup toolbox system comprising:
a pickup truck having a pickup bed, the pickup bed having a floor panel, a first lateral panel, and a second lateral panel, each of the first lateral panel and the second lateral panel extending upwardly from the floor panel and having an upper edge, the pickup bed having a front end and a rear end, the pickup truck having a tailgate positioned at the rear end of the pickup bed;
a front panel being coupled to the pickup bed, the front panel being positioned adjacent the front end of the pickup bed and extending between the first lateral panel and the second lateral panel;
a rear panel being coupled to the pickup bed, the rear panel being positioned adjacent the tailgate of the pickup truck and extending between the first lateral panel and the second lateral panel;
the pickup bed, the front panel, and the rear panel collectively defining a container forming a storage compartment, a top side of the container being open to the storage compartment;
a toolbox being slidably coupled to the front panel and the rear panel, the toolbox being positioned on an upper surface of the front panel and an upper surface of the rear panel, the toolbox covering the storage compartment when in a closed position, the toolbox being movable from the closed position in a first direction over the upper edge of the first lateral panel to expose the storage compartment adjacent to the second lateral panel, the toolbox being movable from the closed position in a second direction over the upper edge of the second lateral panel to expose the storage compartment adjacent to the first lateral panel, the toolbox comprising:
a box having a base wall and a perimeter wall extending upwardly therefrom, the box having a chamber positioned therein and a top side being open to the chamber, the top side facing upwardly away from the pickup bed, the chamber having a first lateral portion positioned adjacent the first lateral panel and a second lateral portion positioned adjacent the second lateral panel when the toolbox is in the closed position;
a first lid being mounted to the box for covering and exposing the first lateral portion of the chamber, the first lid being pivotably coupled to the box; and
a second lid being mounted to the box for covering and exposing the second lateral portion of the chamber, the second lid being pivotably coupled to the box;
a drive assembly engaging the toolbox and being configured for selectively moving the toolbox relative to the pickup bed, the drive assembly comprising a front module engaging the front panel and the toolbox and a rear module engaging the rear panel and the toolbox, each of the front module and the rear module comprising a motor, a pinion, and a rack;
a controller being operatively coupled to the drive assembly, the controller comprising a control circuit and an input module, the input module including a close input for moving the toolbox to the closed position, a first open input for moving the toolbox in the first direction, and a second open input for moving the toolbox in the second direction; and
an extendable support member being slidably mounted to the rear panel such that the support member is extendable rearwardly of the rear panel, the extendable support member including a pair of lateral sliders and a cross member being coupled to and extending between the pair of lateral sliders, the rear panel having a pair of apertures extending therethrough and into the storage compartment, each aperture receiving one of the lateral sliders therethrough, the extendable support member being positionable in a retracted position such that the cross member is positioned adjacent the rear panel, the extendable support member being positionable in an extended position such that the cross member is spaced rearwardly away from the rear panel, the extendable support member being configured for supporting a workpiece across the pair of lateral sliders when in the extended position.
